(19) United States
(12) Patent Application Publication
(10) Pub. No.: US 2008/0149892 A1
(43) Pub. Date: Jun. 26, 2008

(54) METHOD AND PREPARING NANO-SIZED PHOSHPOR POWDERS

(75) Inventors: DAE HO YOON, SUWON-SI (KR); TAKAKI MASAKI, YONGIN-SI (KR); WOO JUNG PARK, YONGIN-SI (KR); MONG KWON JUNG, YONGIN-SI (KR)

Correspondence Address: CANTOR COLBURN, LLP, 20 Church Street, 22nd Floor, Hartford, CT, 06103, US

(73) Assignee: SAMSUNG ELECTRONICS CO., LTD., SUWON-SI (KR)

(21) Appl. No.: 11/933,303

(22) Filed: Oct. 31, 2007

(30) Foreign Application Priority Data
Dec. 22, 2006 (KR) 10-2006-0132685

(51) Int. Cl. C09K 11/78

(52) U.S. Cl. 252/301.4 R

(57) ABSTRACT

Disclosed herein is a method for preparing nanophosphor powders. The method includes impregnating an aqueous solution of one or more metal salts into a fine crystalline polymeric material, drying the impregnated polymeric material, and subjecting the polymeric material to heat-treatment.

### CROSS-REFERENCE TO RELATED APPLICATIONS

This non-provisional application claims priority under 35 U.S.C. § 119 to Korean Patent Application No. 10-2006-0132685, filed on Dec. 22, 2006 in the Korean Intellectual Property Office (KIPO), the entire contents of which are incorporated herein by reference.

### BACKGROUND

1. Field

Example embodiments include a method for preparing nano-sized phosphor powders. Other example embodiments include a method for preparing phosphor powders that have a uniform particle size and are applicable to displays.

2. Description of the Related Art

With the rapid development in the field of displays, techniques associated with displays have actively progressed. In particular, a phosphor is an essential requirement for color-representation of display devices. Accordingly, intense research associated with the phosphor is being made to realize more superior color-representation.

Sulfide phosphors generally exhibit high luminescence efficiencies, but are inapplicable to common displays due to their bad stability when exposed to vacuum ultraviolet irradiation. Thus, oxide phosphors are commonly used as phosphors for displays.

One of red phosphors generally used for displays is (Y, Gd)₂BO₃:Eu³⁺ that has three photoluminescence spectra in a range from 580 nm to 650 nm. High-intensity peaks at 580 nm to 605 nm (orange-color) included in the spectra causes a deterioration in color purity. To solve the problem, the phosphor is used in conjunction with a Y₂O₃:Eu or Gd₂O₃:Eu phosphor that show high-intensity peaks at 600 to 625 nm.

Phosphor powders must have a uniform particle size of 3 to 5 μm and have a spherical shape. However, according to a conventional method for preparing phosphor powders, metal oxide is subjected to mixing, drying, calcining and grinding. The phosphor particles thus prepared undesirably have a non-uniform size of 1 to 20 μm. This method has several disadvantages of long preparation time, the necessity of calcination at a high temperature (i.e. 1,500° C. or higher) due to the use of oxide as a starting material, non-uniformity in the composition and size of particles caused by a solid state reaction between the particles, the necessity of grinding for a long time, and deterioration in purity and properties of phosphors due to contamination. For example, to prepare Y₂O₃:Eu or Gd₂O₃:Eu phosphor powders, yttrium oxide, gadolinium oxide, europium oxide and the like must be uniformly mixed for a long period of time, dried and heated at 1,500° C. or higher. Furthermore, despite addition of a flux such as H₃BO₃, NHF₄ or CaF₂, high-temperature heating is inevitable.

As other methods for preparing phosphor powders, there may be exemplified a liquid phase method, vapor deposition and coprecipitation. These methods enable preparation of spherical-shape phosphor particles, but have drawbacks of non-uniform particle size, complicated equipment and unsuitability for mass-production. Although the methods are involved in a simple process, in a multi-component system, it is difficult to obtain a compound with a uniform composition, thus making it impossible to realize uniform powder particles.

As the prior arts, there may be mentioned a method for preparing spherical-shape boron oxide red phosphors. According to this method, tetraethylorthosilicate (TEOS) is added to ethyl alcohol to induce hydrolysis. The resulting product was precipitated in silica hydrate and filtered. The silica hydrate was dispersed in an aqueous solution containing yttrium, gadolinium, europium and boron. A basic solution was added to the dispersion to coprecipitate the components as hydroxide. The coprecipitate was dried and was then heated to prepare phosphors. This method enables preparation of single-phase phosphors at a low temperature is economical owing to the possibility of using a small amount of expensive rare earth elements (e.g. yttrium, gadolinium and europium) and enables realization of phosphor particles that are hardly aggregated and have a uniform spherical shape, after high-temperature heating. The prior art is characterized in that (Y,Gd)BO₃:Eu red phosphors are applied to plasma display panels (PDPs) to form high-density phosphor layers, thereby considerably contributing to improvement in performance of the PDPs. However, the method has disadvantages of a complicated preparation process, long preparation time and excessive reduction in luminance.

Accordingly, there is a need to develop uniform-shape phosphors applicable to displays and a method for easily preparing the same.

### SUMMARY OF THE INVENTION

In one example embodiments, the present invention provides a method for preparing nanoscale phosphor powders with a uniform particle size and composition which is carried out at a low temperature in a simple manner.

In another embodiment, the present invention provides a method for preparing nanoscale phosphor powders that exhibit superior fluorescence properties, as compared to conventional phosphor powders.

In accordance with example embodiments of the present invention, there is provided a method for preparing nanoscale phosphor powders comprising:

impregnating an aqueous solution of one or more metal salts into a fine crystalline polymeric material;

drying the impregnated polymeric material; and

subjecting the polymeric material to heat-treatment.

Unlike to the conventional methods, the method according to the present invention enables preparation of nanophosphors at a low temperature in a simple manner, by which a fine-crystalline polymeric material is used. Uniform nanophosphor powders can be prepared by impregnating an aqueous solution of one or more metal salts into a fine crystalline polymeric material, drying the impregnated polymeric material and removing the polymeric material by heat-treatment.

The method may further comprise grinding the nanophosphor powders after heat-treatment. This step is a post-processing commonly used in the art to powder the nanophosphor that is in an oxide powder (e.g. fiber-phase) aggregated by weak force.

### BRIEF DESCRIPTION OF THE DRAWINGS

Example embodiments will be more clearly understood from the following detailed description taken in conjunction with the accompanying drawings. FIGS. 1-7 represent non-limiting, example embodiments as described herein.

FIG. 1 is a flowchart illustrating a method for preparing nanophosphor powders according to the present invention;

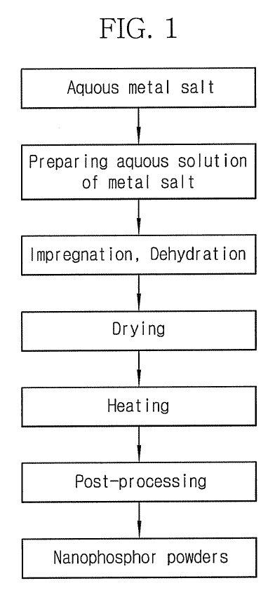

FIG. 2 is X-ray diffraction spectra of (Y,Gd)₂O₃:Eu phosphor powders prepared under various conditions of heating temperature according to the present invention;

FIG. 3 is SEM images showing a particle state and size of (Y,Gd)₂O₃:Eu phosphor powders prepared at heating temperatures of 800° C. and 900° C. according to the present invention;

FIG. 4 is photoluminescence (PL) spectra upon excitation at 254 nm of (Y,Gd)₂O₃:Eu phosphor powders of the present invention under various conditions of heating temperature;

FIG. 5 is photoluminescence (PL) spectra upon excitation at 390 nm of (Y,Gd)₂O₃:Eu phosphor powders of the present invention under various conditions of heating temperature;

FIG. 6 is photoluminescence (PL) spectra upon emission at 613 nm of (Y,Gd)₂O₃:Eu phosphor powders of the present invention under various conditions of heating temperature; and

FIG. 7 shows comparison in photoluminescence (PL) spectra between the phosphor of the present invention and a conventional phosphor.

### DESCRIPTION OF THE PREFERRED EMBODIMENTS

Hereinafter, a detailed description of the exemplary embodiments of the present invention will be provided with reference to the accompanying drawing.

Example embodiments are directed to a method for preparing nanoscale phosphor powders comprising: impregnating an aqueous solution of one or more metal salts into a fine crystalline polymeric material; drying the impregnated polymeric material; and subjecting the polymeric material to heat-treatment.

Nanophosphors enable efficient control of recombination behaviors between electrons and holes owing to their small particle size and reduce aftergrow time. These phenomena are based on the fact that as compared to bulky particles, nanoparticles undergo great variation in energy level due to great restriction on electron/hole behaviors which affect the rate of recombination between electrons and holes in active ions present as impurities. As such, nanophosphors have advantages of quantum-size effects caused by reduced physically allowed quantum states which results from a large bandwidth due to their small particle size, and interface effects based on increased surface area to volume ratio. When comparing fluorescence properties of nano-scale phosphors with those of conventional micron-scale phosphors, the nano-scale phosphors exhibit relatively superior luminescence and better properties. These results indicate that the afore-mentioned quantum-size and interface effects contribute to improvement in fluorescence efficiency of phosphors.

In the first step, an aqueous solution of one or more metal salt is impregnated into a fine crystalline polymeric material. The metal of the metal salt that can be used in the present invention is not particularly limited and specific examples thereof includes yttrium (Y), gadolinium (Gd), boron (B), europium (Eu), cerium (Ce), promethium (Pr), samarium (Sm), manganese (Mn) and a combination thereof.

The metal salt is a water-soluble metal salt that is well miscible with water to form an aqueous solution and examples thereof include metal chloride, metal nitride, metal sulfide, metal fluoride and metal oxide. Preferred is the use of metal chloride that is the most suitable for preparing final oxide at a lower temperature.

Since the metal salt is reacted in an aqueous solution phase, it may be quantitatively added, based on the mole of the metal contained in the final phosphor oxide. Accordingly, control over the content of the metal salt enables easy control of a molar ratio of a final phosphor oxide.

In a case where a flux is used to lower a heating temperature, the flux is dissolved in the aqueous metal salt solution. Examples of the flux usable herein include H₃BO₃, NHF₄, CaF₂, BaCl₂ xH₂O and MgF₂.

The polymeric material well absorbs the aqueous metal salt solution and includes at least one matrix selected from the group consisting of amorphous or crystalline cellulose, wood, pulp, acetate, and rayon cellophane. As a fine polymeric material, it is preferable to use a fine-cell structural material such as cellophane or wood. More preferred is the use of cellulose.

Preferably, the polymeric material is composed of fine crystals with a size of 10 Å to 300 Å.

This step, impregnation of the polymeric material with the aqueous metal salt solution, allows the aqueous metal salt solution to be absorbed in fine crystals (i.e. 10 to 300 Å) present in the matrix of the polymeric material. The resulting fine crystals are dried to obtain amorphous fine powders.

During the impregnation, a weight ratio between the polymeric material and the aqueous metal salt solution polymeric material is controllable, but is preferably adjusted to 1:1. When the impregnation is carried out under vacuum, the metal salt solution is readily permeated into the fine crystals present in the polymeric material, thus making it possible to increase a yield.

Besides, when an excessive amount of the metal salt solution exists on the surface of the polymeric material, salt crystals are deposited on the surface thereof or a large cluster of salts are formed thereon. To prevent these undesirable phenomena, the remaining metal salt solution must be removed with a compressor (e.g. centrifuge or roller). In the present invention, the remaining metal salt solution removed with the compressor may be recycled.

In the following step, the polymeric material, into which the metal salt solution is impregnated, is dried and heated at 600 to 1,700° C. for 30 minutes to 3 hours.

The drying of the impregnated polymeric material is carried out by hot-air drying for 4 hours or more and the drying temperature elevates to 400° C. at a rate of 100° C./time to 200° C./time to remove the polymeric material. At this time, the metal salt is partially carbonized. Then, the metal salt is oxidized by heat-treatment at 600° C. to 1,700° C. to prepare phosphor powders.

The phosphor powders thus prepared are oxide powders which are aggregated by weak force. The phosphor powders are treated with a conventional post-processing method. For example, phosphor powders are grinded in a mortar.

A phosphor powder that can be prepared by the method may be of any type. Specific examples of phosphor powders includes, but are not limited to nanopowders that has a particle size of 10 to 800 nm and is represented by the following Formula 1:

(YₓGd_{y})₂B_{z}O₃:Aₐ (1)

wherein A is at least one selected from europium (Eu), cerium (Ce), promethium (Pr), samarium (Sm) and manganese (Mn); and 0≦x≦1, 0≦y≦1, 0≦z≦1 and 0≦a≦1.

The nanophosphor powders prepared by the method have a spherical shape and the size thereof depends on a heating temperature. In particular, the nanophosphor powders exhibit superior phosphorescence efficiency, as compared to phosphor powders commonly used in the art.

Hereinafter, the present invention will be explained in more detail with reference to the following examples. However, these examples are given for the purpose of illustration and are not intended to limit the present invention.

### EXAMPLES

### Example 1

### Preparation of (Y, Gd)₂O₃:Eu Red Nanophosphor Powders

Yttrium chloride 6-hydrate, gadolinium (III) chloride 6-hydrate and europium chloride 6-hydrate were mixed to prepare a metal salt with a composition of (Y_{0.68}Gd_{0.264})₂O₃:Eu_{0.056}. The metal salt was dissolved in distilled water to prepare an aqueous metal salt solution (ca. 0.3 M). 10 g of the metal salt solution was impregnated into 10 g of a cellulose pulp (C₆H₁₀O₆)ₙ. Then, the cellulose pulp was vacuumed at a pressure of −100 kPa or less, the remaining solution was removed with a centrifuge and the cellulose pulp was dried at 90° C. for 8 hours. The resulting cellulose pulp was heated to 300° C. at a rate of 4° C./min. After the heating temperature elevates up to 500° C. to 1,400° C., the cellulose pulp was stood for one hour and allowed to cool. The afore-mentioned reaction was depicted by Reaction scheme 1 below:

### Reaction scheme 1

(C₆H₁₀O₆)ₙ cellulose pulp+Y₂Cl₃.ₙH₂O+Gd₂Cl₃.ₙH₂O+Eu₂Cl₃.ₙH₂O->HCl+H₂O+CO₂+(Y,Gd)₂O₃:Eu

The fibrous powders thus prepared were grinded in a mortar to prepare a phosphor.

The phosphor was analyzed by X-ray diffraction, scanning electron microscopy and measurement of excitation/emission wavelength.

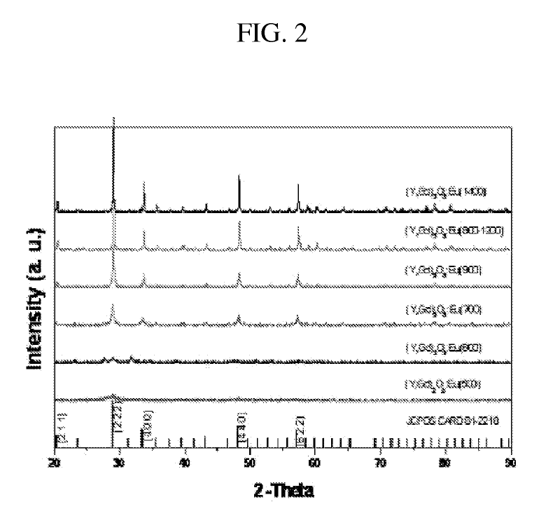

Analysis results obtained from X-ray diffraction reveal that the phosphor powders show no crystallinity at 600° C. or below and show crystallinity at a temperature of 700° C. or higher, and as temperature increases, crystallinity is improved (shown in FIG. 2).

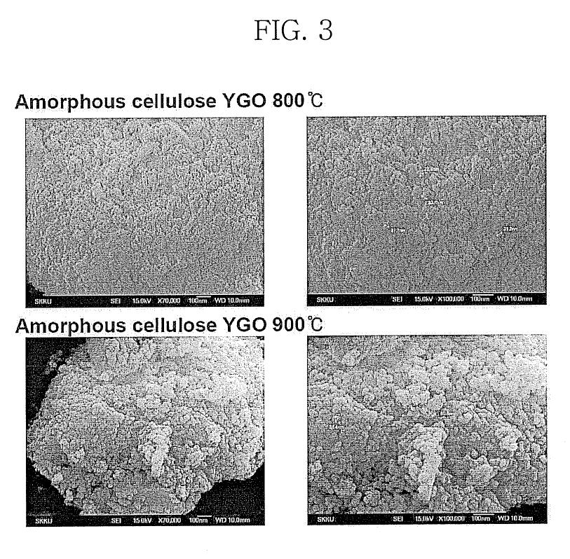

According to the scanning electron microscopy analysis, the phosphors heated at 800° C. and 900° C. have a spherical particle shape, and the particle size increases, with an increase in temperature (shown in FIG. 3).

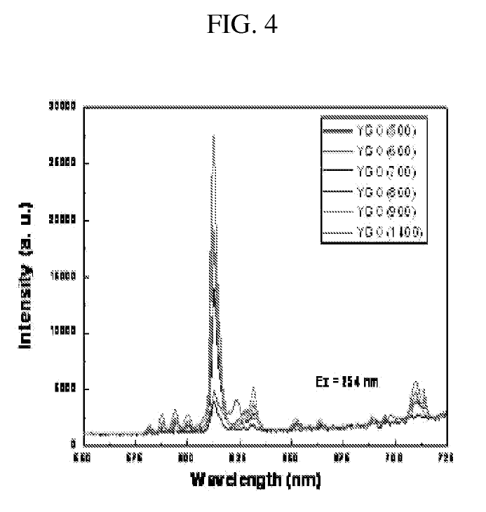

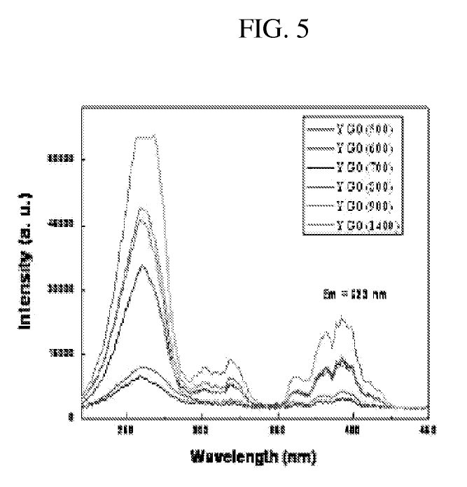

In emission spectra of the phosphor powders, the peak at 588 nm corresponds to ⁵D₀→⁷F₀ transition and peaks at 594 nm and 601 nm correspond to ⁵D₀→⁷F₁ transition. The highest intensity peaks at 613 nm and 628 nm correspond to ⁵D₀→⁷F₂ transition. The peak at 652 nm is attributed to ⁵D₀→⁷F₃ transition (FIGS. 4 and 5).

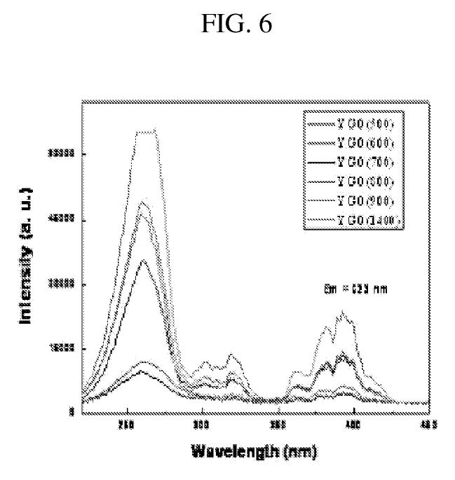

In excitation spectra, broad peaks are observed at a range from 240 to 285 nm and weak peaks were observed at about 400 nm (FIG. 6).

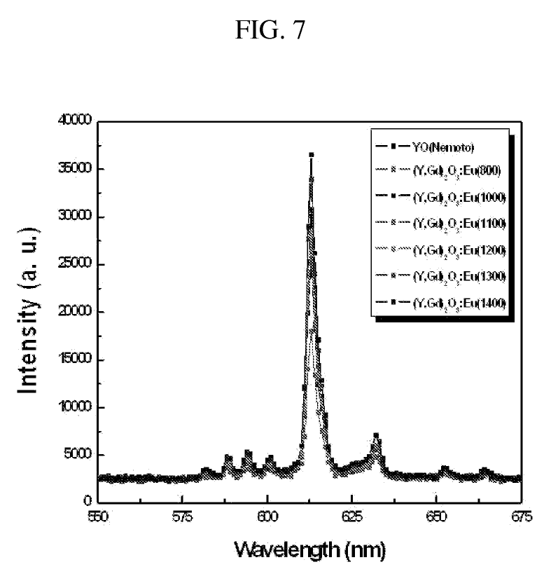

FIG. 7 shows comparison in luminescence efficiency between the phosphor of the present invention and a conventional phosphor (Nemoto, Japan). The phosphor prepared at a heating temperature of 1,300° C. and 1,400° C. according to the present invention exhibits an about 10% or more improvement in luminescence efficiency, as compared to the conventional phosphor (represented by red lines).

As apparent from the foregoing, the method for preparing nanophosphors according to the present invention avoids the necessity of a long-time procedure involving mixing, drying, calcining and grinding, enables considerably rapid preparation of nanophosphor powders in a simple manner through low-temperature (i.e. 600° C.) processes, as compared to conventional methods. Furthermore, the nanophosphors thus prepared exhibit superior fluorescence properties, as compared to conventional phosphor powders.

Example embodiments have been described in detail with reference to the foregoing preferred embodiments. However, example embodiments are not limited to the preferred embodiments. Those skilled in the art will appreciate that various modifications and variations are possible, without departing from the scope and spirit of the appended claims. Accordingly, such modifications and variations are intended to come within the scope of the claims.

What is claimed is:

1. A method for preparing nanophosphor powders comprising:
impregnating an aqueous solution of one or more metal salts into a fine crystalline polymeric material;
drying the impregnated polymeric material; and
subjecting the polymeric material to heat-treatment.

2. The method according to claim 1, further comprising grinding the nanophosphor powders, after the heat-treatment.

3. The method according to claim 1, wherein the polymeric material has crystals with a size of 10 Å to 300 Å.

4. The method according to claim 1, wherein the polymeric material includes at least one matrix selected from the group consisting of amorphous or crystalline cellulose, wood, pulp, acetate and rayon cellophane.

5. The method according to claim 4, wherein the polymeric material is a cellulose pulp.

6. The method according to claim 1, wherein the metal of the aqueous metal salt solution includes at least one selected from yttrium (Y), gadolinium (Gd), boron (B), europium (Eu), cerium (Ce), promethium (Pr), samarium (Sm) and manganese (Mn).

7. The method according to claim 1, wherein the metal salt is metal chloride, metal nitride, metal sulfide, metal fluoride or metal oxide.

8. The method according to claim 1, wherein a weight ratio of the polymeric material and the aqueous metal salt solution is 1:1.

9. The method according to claim 1, further comprising dissolving a flux selected from H₃BO₃, NHF₄, CaF₂, BaCl₂.xH₂O and MgF₂ in the aqueous metal salt solution.

10. The method according to claim 1, wherein the heat-treatment is carried out at 600° C. or higher.

11. The method according to claim 10, wherein the heat-treatment is carried out at 600° C. to 1,700° C. for 30 minutes to 3 hours.

12. The method according to claim 2, wherein the grinded nanophosphor powders have a particle size of 10 to 800 nm.

13. The method according to claim 1, wherein the nanophosphor powders are represented by Formula 1 below:
(YₓGd_{y})₂B_{z}O₃:Aₐ (1)
wherein A is at least one selected from europium (Eu), cerium (Ce), promethium (Pr), samarium (Sm) and manganese (Mn); and 0≦x≦1, 0≦y≦1, 0≦z≦1 and 0≦a≦1.
